(19) United States
(12) Patent Application Publication
(10) Pub. No.: US 2018/0073222 A1
(43) Pub. Date: Mar. 15, 2018

(54) Water Directing and Distribution System

(71) Applicant: Richard A. Romine, Westminster, CA (US)

(72) Inventor: Richard A. Romine, Westminster, CA (US)

(21) Appl. No.: 15/701,114

(22) Filed: Sep. 11, 2017

Related U.S. Application Data
(60) Provisional application No. 62/393,050, filed on Sep. 11, 2016.

(51) Int. Cl. E03B 3/04; E03B 11/02; E03B 9/02; E03B 7/07; E02B 9/04; C02F 1/00

(52) U.S. Cl. CPC E03B 3/04; E03B 11/02; E03B 9/02; C02F 2103/007; E02B 9/04; C02F 1/006; E03B 7/074

(57) ABSTRACT

A water directing and distribution system (WDDS) that functions in combination with a natural or man-made water source. The WDDS includes a main pipe with an intake and a termination point. The main pipe is placed into or adjacent to the water source, at a depth below the water source's surface. Water from the water source enters the pipe at the intake and flows through the pipe by force of gravity. The water is maintained within the pipe and directed through the pipe at a lower level than the water source's origination point. Water from the pipe can be accessed via taps placed along the pipe. The water can also be directed to a water storage structure(s) and can be purified for human or animal consumption.

### TECHNICAL FIELD

The invention generally pertains to water systems, and more particularly to a water directing and distribution system that utilizes gravity-powered water flow through pipes from an existing water source such as a river.

### BACKGROUND ART

One of the most important necessities for life on our planet is water. Humans, animals and plants all rely on water to live and grow. To see to this need Mother Nature has provided rain, as well as numerous rivers, lakes and other water sources, many of which are fresh water (as opposed to salt water as present in the oceans and not possible for human or animal consumption).

Although there are these numerous water sources, there are also problems associated with them. Mankind has polluted a significant number of fresh water (and salt water) sources, and accessing and distributing the water is often difficult. Steps have been taken to stop the further pollution of water, but there still remains the problem of accessing and distributing water, especially as the number of people on our planet increases, and people move into more remote locations to live. Efforts and plans have been enacted to address this problem, but hindrances including implementation and cost have created obstacles.

What is needed is a way to utilize existing water sources such as waterways including rivers and lakes to increase the supply of water. Optimally, a system can be provided which uses gravity, therefore no power requirements and potential power-related problems, pollution or cost, to move water from one location to another, either in or along a waterway. The necessary pipes would be below the navigable waterline, or below the frost line of the ground, which would allow the adjacent land to be used for other purposes such as agriculture. A system such as this could be implemented/built quickly, easily and relatively less costly than other water-production facilities, and could be used throughout the world to supply water for various needs, including drinking water for humans and animals.

A search of the prior art did not disclose any literature or patents that read directly on the claims of the instant invention. However, the following U.S. patents are considered related:

| PAT. NO. | INVENTOR | ISSUED |
|---|---|---|
| 5,102,259 | York, et al | Apr. 7, 1992 |
| 5,735,635 | Johnston, et al | Apr. 7, 1998 |
| 2012/0216457 | Robb | Pub. Date: Aug. 30, 2012 |

The U.S. Pat. No. 5,102,259 patent discloses a sub-surface irrigation system that includes a conduit connected to a water supply. A plurality of fluid dispenser units are connected to a conduit or conduits, and each unit includes a connector at one end to the interior of the conduit. The other-end of the connector is coupled to a drip emitter positioned in an elongated casing. The elongated casing has an enlarged opening at one end and a reduced opening formed at the other end. The drip emitter is positioned in tubing adjacent the reduced opening end.

The U.S. Pat. No. 5,735,635 patent discloses a modular plant irrigation system using any container as a reservoir to hold water. The system includes a detachable manifold connected to the reservoir, one or more detachable dripper devices to produce by gravity droplets of water to flow through detachable tubing of selectable sizes and lengths from the manifold to a variable number and types of plant sites, and additional control devices at either or both the dripper devices and the plant sites to individually control the amount of water flow to each plant site.

The 2012/0216457 publication discloses a gravity food subterranean system for watering plants at their roots. The system comprises a vertically disposed reservoir buried at least partially in the ground, a water input line having positive water pressure connected to a flat valve constructed and arranged within the reservoir such that when the liquid in the reservoir reaches a desired level, the float valve stops water flow from the input line. A buried output line connected to the reservoir below ground level on one end and plugged at the other causes the water in the reservoir to gravity pressurize and fill the output line.

For background purposes and indicative of the art to which the invention relates, reference may be made to the following remaining patents found in the patent search.

| PAT NO. | INVENTOR | ISSUED |
|---|---|---|
| 3,518,831 | Tibbals, Jr., et al | Jul. 7, 1970 |
| 4,419,235 | Sway | Dec. 6, 1983 |
| 5,024,555 | York | Jun. 18, 1991 |
| 9,352,979 | Kuennen, et al | May 31, 2016 |

### DISCLOSURE OF THE INVENTION

A water directing and distribution system (WDDS) that functions in combination with a natural or man-made water source. The WDDS has at least one main pipe with an intake and a termination point. The main pipe is placed into or adjacent to the water source, at a depth below the water source's surface. When the water source is at a constant level, the intake can be placed at a higher elevation than the termination point. Water from the water source enters the pipe at the intake and flows through the pipe by force of gravity. The water is maintained within, and directed through, the pipe at a lower level than the water source's origination point.

From the main pipe water can be accessed by at least one, and preferably multiple water taps, which can be a simple opening in the pipe or an automatic valve. Water can also be directed to at least one water storage structure which is located adjacent to the pipe, or at a distance from the pipe. When a storage structure is at a distance from the main pipe, an extension pipe branching off from the main pipe is utilized.

Additionally, to make the water from the water source safe for human or animal consumption, a water treatment means such as a sterile storage container housing a water purification device can be used. To provide access to the water from the main pipe at a distance from the main pipe, at least one standpipe can be attached to an extension pipe branching off from the main pipe. Each standpipe is drilled to and placed at a selected depth to increase pressure for replenishing the ground water or water source levels.

In view of the above disclosure, the primary object of the invention is to provide a water directing and distribution system that allows water from a water source to be directed by force of gravity through a pipe to a series of water outlets or structures such as artesian wells along waterways.

In addition to the primary object of the invention it is also an object of the invention to provide a water directing and distribution system that:
is easy to install,
requires little or and no maintenance,
can be used throughout the world,
can significantly increase water availability in many locations,
is an effective alternative to conventional water distribution systems,
does not negatively affect the surrounding environment.
is placed below the frost line to keep water from freezing, and
is cost effective from both a manufacturer's and end user's point of view.

These and other objects and advantages of the present invention will become apparent from the subsequent detailed description of the preferred embodiment and the appended claims taken in conjunction with the accompanying drawings.

### BRIEF DESCRIPTION OF THE DRAWINGS

FIG. 1 is a top plan view of a water directing and distribution system (WDDS) in a water source below the waterline.

FIG. 2 is an elevational side cut-a-way view of the WDDS in a water source below the waterline, with taps and valves extending upward out of the water source.

FIG. 3 is a top plan view of the WDDS in a water source below the waterline with a storage structure, water treatment means, a power source and a remotely-located standpipe.

FIG. 4 is a top plan view of the WDDS adjacent to a water source, below the waterline, and below the frost line of the adjacent ground.

### BEST FOR CARRYING OUT THE INVENTION

The best mode for carrying out the invention is presented in terms of a preferred embodiment with multiple design configurations of a water directing and distribution system (WDDS 10).

The inventive concept of the WDDS 10 involves generating a series of water structures such as artesian wells along major rivers and waterways of the world. The WDDS 10 involves laying a sealed pipe into or adjacent to a river waterway at depths below the surface to allow navigation and below frost levels when necessary. The pipe would have a protected intake upriver and be sealed at some point downstream. The waterway would be capable of providing sufficient water and altitude difference in any direction from its origination point. Even a waterfall could be a viable source capable of supplying a large quantity of water.

The primary purpose of the pipe is to maintain a water column to generate and maintain water under pressure. Water taps could be installed with electrically or manually operated valves to control water flow. During wet spells (even flooding) water could be siphoned and diverted to ponds and lakes to refresh ground water that could be used by humans, wildlife and as irrigation water for crops.

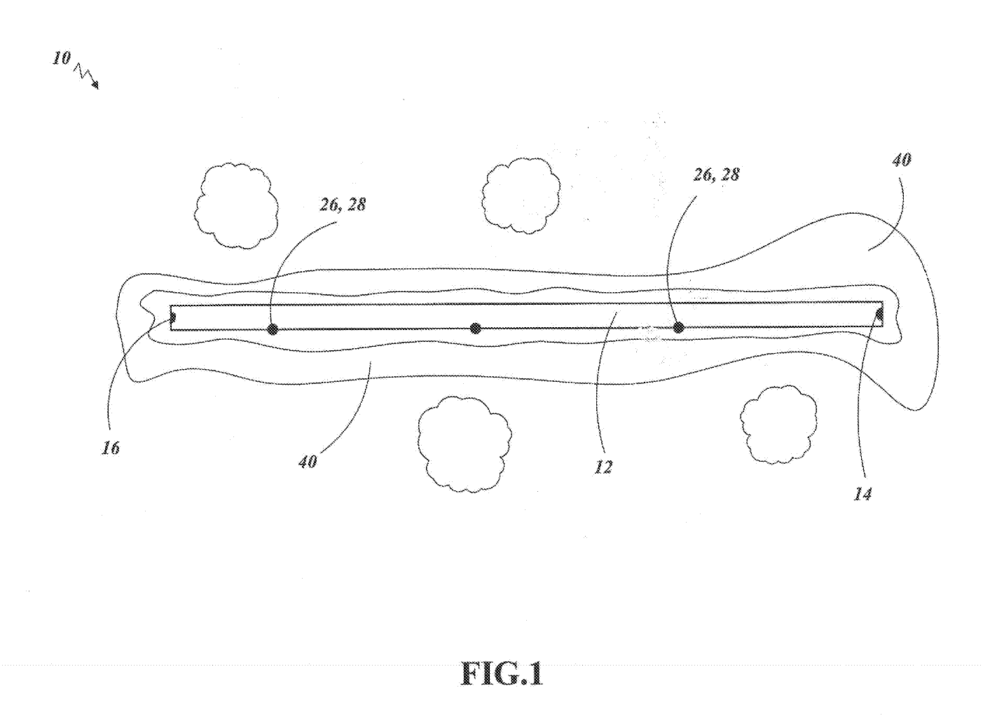

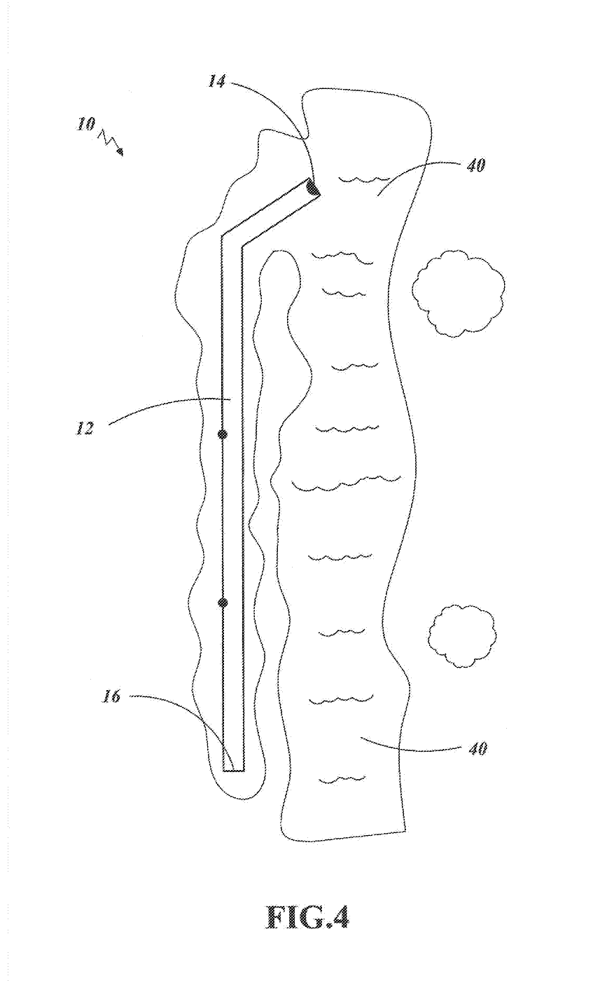

The WDDS 10, as shown in FIGS. 1-4, functions in combination with an existing natural or man-made water source 40 such as a river, stream or other waterway. Alternately, a water source could be created expressly for use with the WDDS 10. At least one main pipe 12 having an intake 14 and a termination point 16 is placed into, as shown in FIGS. 1-3, or adjacent, as shown in FIG. 4, to the water source 40. The intake 14 can simply be an opening in the pipe 12, or can be comprised of a device such as an automatic valve. The pipe 12 is at a depth below the water source's surface and in cases where the water source is at a constant level, the main pipe's intake 14 can be placed at a higher elevation than the termination point 16. The pipe placement depth is important because the depth facilitates the direction(s) the pipe is laid, and therefore the direction(s) the water travels, and at a level deep enough to ensure that the water in the pipe 12 does not freeze (is below the frost level). Also, during directing and distribution there is no loss of water due to evaporation.

Water from the water source 40 enters the pipe 12 at the intake 14 and flows through the pipe 12. One of the most important inventive concepts of the WDDS 10 is that the water flows through the pipe 12 by force of gravity. No pumps or other external or internal power is required. The direction(s) the pipe 12 travels, as well as other pipe placement characteristics are designed to use gravity in the most optimal manner possible. When in use, the WDDS 10 provides a directed quantity of water that is maintained under pressure, at a lower level than the water source's 40 origination point.

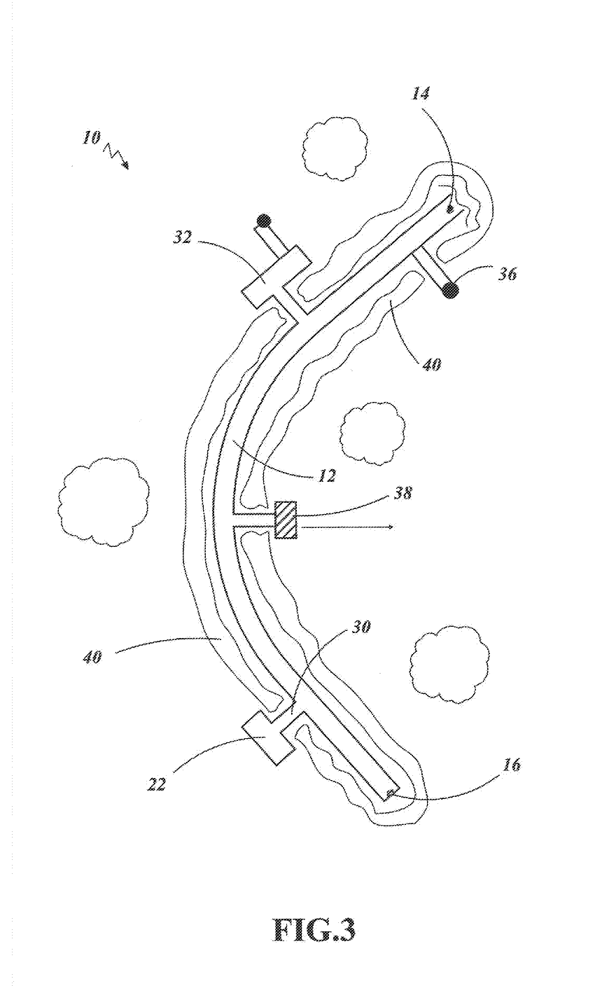

As shown in FIG. 3, at least one water storage structure 22 can be placed along the pipe 12. The storage structure 22 allows water to be diverted from the pipe 12 into the structure 22 for later use. The number of storage structures 22 that are used, the location of each structure, and the storage capability of each structure, are selectably determined by requirements/desire of the user(s) and by the distance the pipe 12 travels. The amount of water flowing through the WDDS 10 also determines how many storage structures are required or possible. The storage structure(s) 22 can be made of various materials such as plastic or metal, can be any shape or size, and can be placed above or below ground. The above attributes are all determined by the application of a particular WDDS 10.

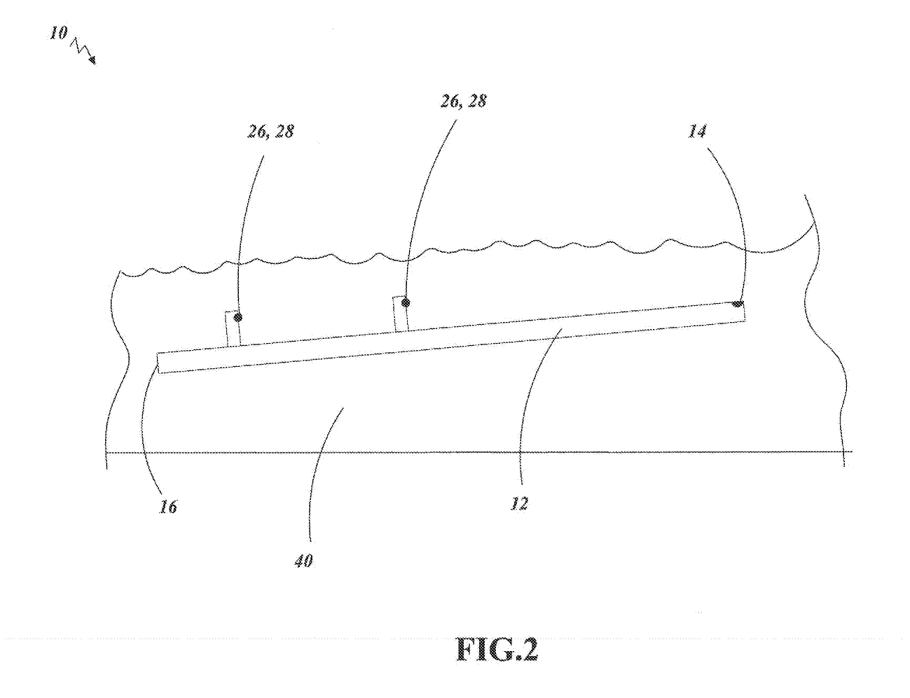

At least one water tap 26, as shown in FIGS. 1 and 2, can also be included. Each tap 26 includes a power or manually actuated valve 28 to control the flow of water in the pipe 12 at the particular location of the tap 26. The tap(s) 26 could facilitate the irrigation of fields/crops, manufacturing; providing bio-fuel; drinking water (after purification); water storage; the creation or maintaining of small or large, natural or artificial lakes/ponds for recreation; and for a variety of other purposes.

When using the storage structures 22 and/or taps 26, at least one extension pipe 30, as shown in FIG. 3, can be branched off of the main pipe 12. The extension pipe 30 allows a quantity of water to be directed/distributed to a location away from the main pipe 12. An extension pipe 30 is especially viable when the main pipe 12 is travelling through a location where accessibility is limited or non-existent, or at a location not adjacent to the main pipe 12.

As previously disclosed, the WDDS 10 can provide drinking water, but only after the water has been purified and made safe for human/animal consumption. In order to provide safe, consumable water, water treatment means 32, as shown in FIG. 3, is utilized. There are numerous treatment means 32 that can be utilized to purify the water, for example: solar distillation, boiling, filtration, ultraviolet exposure, a chemical method, or nuclear radiation. Most of these means, all of which are well-known in prior art, will require transferring/directing the un-treated water from the main pipe 12 to a sterile storage container that houses a purifying device where the actual process and treatment occurs. From the container, the purified water can be directed to a storage structure (as previously described) or to designated outlets. Whichever treatment means 32 is utilized depends on various factors including the amount of purified water that is required/desired, environmental concerns, difficulty of implementation, and cost.

In order to increase the functionality of the WDDS 10, additional features/capabilities can be included. The pressurized water in the pipe 12 can be directed to at least one remotely located standpipe 36, as shown in FIG. 3 that allows water from the pipe 12 to be accessed at a distance from the pipe 12. Each standpipe 36 is drilled to and placed at a selected depth to increase pressure for replenishing ground water/water source levels. The standpipe 36 could also provide access to the ground water/water source during times of drought.

Also, as shown in FIG. 3, a power generator 38, such as a turbo generator could be placed/installed external and adjacent to the pipe 12 at a location where the water flow and pressure level are sufficient to produce electricity.

The proposed system for distributing water for storage instead of allowing it to all flow into the oceans should be generally acceptable and positive for the economy of any applicable municipality, state, country or country. There are no negative ramifications resulting from the installation of a pipe that carries only water and is buried at depths below the water line. Farmers can grow crops over the pipe and may have a water source available during drought. Once installed the pipes are dedicated to supplying water for human or animal consumption, storage, irrigation and recreation, and will additionally provide many job opportunities. After completion the only need for easements will be for access to maintain the pipe.

In order to fully disclose the functionality and capability of the WDDS 10, the following example using the Mississippi River in the United States of America is presented.

The Mississippi River originates at an altitude of 1473 feet and travels 2340 miles to the gulf which is assumed 0 feet in altitude. This means the average drop 1473/2340=0.63 feet per mile, for this example the pipe is 100 miles long with an average change in elevation of 63 feet. It is known that for every 33 feet of depth (altitude change) the water pressure increases by 14.5 psi, so the water pressure available at this location would be: 14.5×63/33=27.7 psi. This resulting water pressure will allow the delivery of water at a pressure about 14 psi at 31.5 feet above the river level. If more pressure is needed the pipe can be extended, taps could be placed al various locations downstream, and the water flow could be balanced to intermediate supply needs.

While the invention has been described in detail and pictorially shown in the accompanying drawings it is not to be limited to such details, since many changes and modification may be made to the invention without departing from the spirit and the scope thereof. Hence, it is described to cover any and all modifications and forms which may come within the language and scope of the claims.

1. A water directing and distribution system (WDDS) that functions in combination with a water source, wherein said WDDS is comprised of at least one main pipe having an intake and a termination point, wherein said main pipe is placed into or adjacent to the water source, at a depth below the water source's surface, wherein water from the water source enters said pipe at the intake and flows through said pipe by force of gravity, wherein the water is maintained within said pipe and directed through said pipe at a lower level than the water source's origination point.

2. The water directing and distribution system as specified in claim 1 wherein the water source is a natural water source.

3. The water directing and distribution system as specified in claim 1 wherein the water source is a man-made water source.

4. The water directing and distribution system as specified in claim 1 wherein the water source is at a constant level, said main pipe's intake is at a higher elevation than the termination point.

5. The water directing and distribution system as specified in claim 1 wherein the water source is selected from the group consisting of a river, a stream, a lake, an ocean, an inland sea, a fjord, a basin, an underground lake, or a waterfall.

6. The water directing and distribution system as specified in claim 1 wherein said main pipe is made of a material selected from the group consisting of metal, plastic or a composite.

7. The water directing and distribution system as specified in claim 1 wherein said main pipe's intake is comprised of an opening in said pipe.

8. The water directing and distribution system as specified in claim 1 wherein said main pipe's intake is comprised of an automatic valve.

9. The water directing and distribution system as specified in claim 1 further comprising at least one water storage structure that, in combination with an extension pipe, is placed along said main pipe, wherein said water storage structure allows water to be diverted from said main pipe into said storage structure for later use.

10. The water directing and distribution system as specified in claim 9 wherein said at least one water storage structure is made of a material selected from the group consisting of metal or plastic.

11. The water directing and distribution system as specified in claim 9 wherein said at least one water storage structure is placed above or below ground.

12. The water directing and distribution system as specified in claim 1 further comprising at least one water tap that is located on said pipe and includes a power or manually actuated valve to control the flow of water in said pipe.

13. The water directing and distribution system as specified in claim 1 further comprising at least one extension pipe that branches off said main pipe, wherein said extension pipe allows water to be directed or distributed to a location away from said main pipe.

14. The water directing and distribution system as specified in claim 1 further comprising water treatment means that purifies water from the water source for human or animal consumption, wherein un-treated water is directed from said main pipe to a sterile storage container that houses a purification treatment device, wherein after purification, the water is directed to a storage structure or to outlets.

15. The water directing and distribution system as specified in claim 14 wherein said water treatment means utilizes a purification treatment device that is selected from the group consisting of solar distillation, boiling, filtration, ultraviolet exposure, a chemical method or nuclear radiation.

16. The water directing and distribution system as specified in claim 1 further comprising at least one remotely located standpipe that provides access to water from said main pipe at a distance form said pipe, wherein said at least one standpipe is drilled and placed at a selected depth to increase pressure for replenishing ground water or water source levels.

17. The water directing and distribution system as specified in claim 1 further comprising a power generator that is placed or installed external and adjacent to said main pipe at a location where the water flow and pressure level are sufficient to produce electricity.

18. The water directing and distribution system as specified in claim 17 wherein said power generator is comprised of a turbo generator.

19. A water directing and distribution system (WDDS) that functions in combination with a natural or man-made water source, wherein said WDDS is comprised of at least one main pipe having an intake, a termination point, and multiple taps located along said main pipe wherein said main pipe is placed into or adjacent to the water source, at a depth below the water source's surface, wherein water from the water source enters said pipe at the intake and flows through said pipe by force of gravity, wherein the water is maintained within said pipe and directed through said pipe at a lower level than the water source's origination point, wherein water is accessible from said pipe via said taps.

20. The water directing and distribution system as specified in claim 19 wherein when the water source is at a constant level, said main pipe's intake is at a higher elevation than the termination point.
